(19) United States
(12) Patent Application Publication
(10) Pub. No.: US 2001/0032376 A1
(43) Pub. Date: Oct. 25, 2001

(54) Tabbed binder clips

(76) Inventor: Saundra D. Payne, Simi Valley, CA (US)

Correspondence Address: ROBERT M. SPERRY, ESQ., 23390 OSTRONIC DRIVE, WOODLAND HILLS, CA, 91367, US

(21) Appl. No.: 09/788,583

(22) Filed: Feb. 21, 2001

Related U.S. Application Data
(60) Provisional application No. 60/183,984, filed on Feb. 22, 2000.

(51) Int. Cl. B42F 1/00

(52) U.S. Cl. 24/67.5

(57) ABSTRACT

An improved paper clip having a transparent tubular label holder fixedly mounted thereon at a location which will not interfere with the addition or removal of papers from the clip, yet which will be clearly visible whenever the clipped group of papers is handled.

### RELATED CASES

This invention is described in my copending Provisional Patent Application Ser. No. 60/183,984, filed Feb. 22, 2000 and now ______.

### FIELD OF INVENTION

This invention relates to stationery items and is particularly directed to improved clips having labeling tabs attached thereto to facilitate sorting and identifying clipped documents.

### PRIOR ART

In sorting and filing, it is often necessary or desirable to separate papers and documents into related groups and to attach the groups together to prevent their becoming remixed with the papers of other groups. Numerous types of clips are available for accomplishing this. However, no means has heretofor been provided for conveniently identifying these groups. Conventionally, a slip of paper or cardboard is added to each group and a word or symbol is written on this slip to identify the papers of that group. However, when additional papers are added to the group, the identifying slip is often lost or misplaced, so its purpose is defeated. This adds considerably to the time and effort required for accomplishing the sorting operation and adds substantially to the cost of the operation. Thus, none of the prior art clips have been entirely satisfactory.

### BRIEF SUMMARY AND OBJECTS OF INVENTION

These disadvantages of the prior art are overcome with the present invention and an improved paper clip is provided which enables rapid and simple identification of clipped papers and which prevents loss or misplacement of the label when the grouped papers are handled or when additional papers are added to the clipped group.

These advantages of the present invention are preferably attained by providing an improved paper clip having a transparent tubular label holder fixedly mounted thereon at a location which will not interfere with the addition or removal of papers from the clip, yet which will be clearly visible whenever the clipped group of papers is handled.

Accordingly, it is an object of the present invention to provide an improved paper clip.

Another object of the present invention is to provide an improved paper clip which enables rapid and simple identification of clipped papers.

An additional object of the present invention is to provide an improved paper clip which prevents loss or misplacement of the label when additional papers are added to the clipped group.

A further object of the present invention is to provide an improved paper clip which clearly and visibly identifies the papers retained by the clip.

Another object of the present invention is to provide an improved paper clip which clearly and visibly identifies the papers retained by the clip and which precludes the label from becoming lost or misplaced when the papers retained by the clip are handled or when additional papers are added to the retained group.

A further object of the present invention is to provide an improved paper clip which clearly and visibly identifies the papers retained by the clip and which can quickly and easily be changed when the contents of the clip are changed to properly identify the new contents.

A specific object of the present invention is to provide an improved paper clip having a transparent tubular label holder fixedly mounted thereon at a location which will not interfere with the addition or removal of papers from the clip, yet which will be clearly visible whenever the clipped group of papers is handled.

These and other objects and features of the present invention will be apparent from the following detailed description, taken with reference to the figures of the accompanying drawing.

### BRIEF DESCRIPTION OF THE DRAWING

FIG. 1 is a side view of a clip embodying the present invention;

FIG. 2 is a rear view of the clip of FIG. 1; and

FIG. 3 is an end view of the clip of FIG. 1

### DETAILED DESCRIPTION OF THE INVENTION

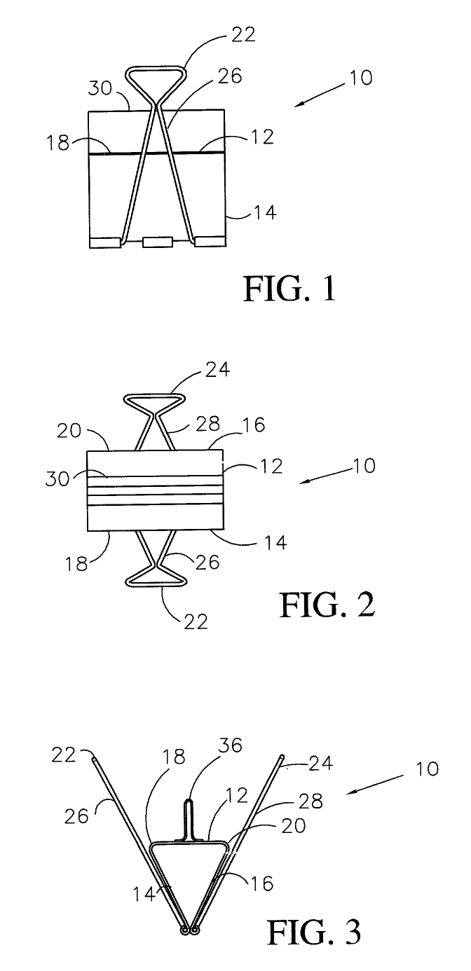

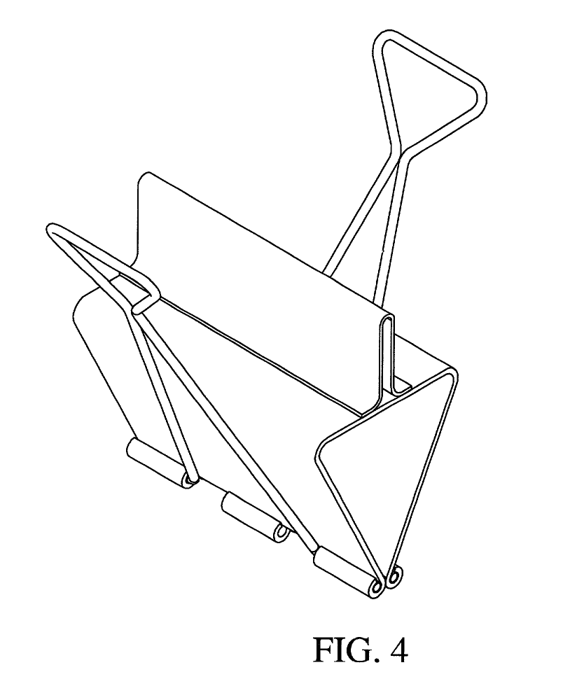

In that form of the present invention, FIG. 1 shows a clip, indicated generally 10, having a base 12 and side members 14 and 16 which project from the opposite edges 18 and 20 of the clip 10 and incline resiliently inwardly toward each other. The base 12 and side members 14 and 16 are preferably formed of resilient material, such as spring metal, so that the side members 14 and 16 will be urged to the position shown. Handles 22 and 24 are attached to the side members 14 and 16 and extend rearwardly beyond the base 12, as seen at 26 and 28, to enable the user to squeeze the portions 26 and 28 together to cause the side members 14 and 16 to spread apart and allow insertion of papers or other articles between the sides 14 and 16 to be gripped by the sides 14 and 16 to retain the articles. A transparent label holder 30 is mounted on the base 12 and projects outwardly therefrom. The label holder 30 is a hollow, flattened tubular member which allows the user to insert a label therein to identify the articles retained by the clip 10.

In use, the user inserts a label into the label holder 30 to identify the papers or other articles retained by the clip 10. Thereafter, the user squeezes portions 26 and 28 of the handles 22 and 24 toward each other, which causes the side members 14 and 16 to spread apart. The user then inserts papers or other articles between the sides 14 and 16 and releases portions 26 and 28 to allow the side members 14 and 16 to return to their normal position and, hence, to grip the papers or articles inserted therebetween. Subsequently, by squeezing portions 26 and 28 of the handles 22 and 24, the user can again press the portions 26 and 28 together to reopen side members 14 and 16 to remove articles or insert additional articles. If several clips are used, each holding groups of related articles, the labels in the holders 30 will serve to quickly and easily identify and distinguish the various groups. If the clip 10 is removed from the articles and the user desires to change the label for reuse with different articles, the user simply slides the label out of the holder 30 and replaces it with a new label for reuse with the new articles.

Obviously numerous variations and modifications can be made without departing from the spirit of the present invention. Therefore, it should be clearly understood that the forms of the present invention described above and shown in the figures of the accompanying drawing are illustrative only and are not intended to limit the scope of the present invention.

What is claimed is:

1. An article clip comprising:
a clip formed of resilient material having a base with two side members projecting outwardly from the opposite edges of said base and inclining toward each other,
handles mounted on said sides members and projecting rearwardly beyond said base, and
a label holder mounted on said base.

2. The clip of claim 1 wherein:
said label holder projects outwardly from said base.

3. The clip of claim 1 wherein:
said label holder projects rearwardly from said base.

4. The clip of claim 1 wherein:
said label holder is transparent.

5. The clip of claim 1 wherein:
said label holder is hollow.

6. The clip of claim 1 wherein:
said label holder is tubular.
